(19) United States
(12) Patent Application Publication
(10) Pub. No.: US 2009/0171782 A1
(43) Pub. Date: Jul. 2, 2009

(54) SYSTEM AND COMPUTER PROGRAM FOR PROVIDING FLIGHT INFORMATION

(75) Inventors: Sam L. Stolbun, Houston, TX (US); Seth L. Stolbun, Houston, TX (US)

Correspondence Address: GARDERE WYNNE SEWELL LLP;INTELLECTUAL PROPERTY SECTION, 3000 THANKSGIVING TOWER, 1601 ELM ST, DALLAS, TX, 75201-4761, US

(73) Assignee: 800-FLIGHTS, LLC, Stafford, TX (US)

(21) Appl. No.: 11/968,586

(22) Filed: Jan. 2, 2008

(51) Int. Cl. G06Q 30/00

(52) U.S. Cl. 705/14

(57) ABSTRACT

A system and a computer program are provided for providing real-time flight information to a user over a telephone network. The system includes a server having access to real-time flight information, an interface in communication with the server and a telephone network, a database in communication with the server. The database is continuously updated with the real-time flight information. The database contains a plurality of advertisements. The server is configured to prompt a user to enter flight identifying information over the telephone network, receive the flight identifying information from the user, determine matching flight information from the database based upon the flight identifying information, and to provide at least one of the plurality of advertisements to the user over the telephone network while the flight information is being determined. Advertiser fees are provided from one or more advertisers for each of the plurality of advertisements provided to the user.

### BACKGROUND OF THE INVENTION

1. Field of the Invention

The present invention is generally related to call centers and telephone systems which process flight information, and more particularly to a system and computer program for providing flight information over a telephone network.

2. Discussion of the Background

There are over 700 million domestic travelers on airline flights every year. Most seasoned travelers and a substantial number of the travelers generally have experienced a delay in either arrival or departure times. According to the Federal Aviation Administration, from November 2005 to November 2006 almost twenty-five percent of all national arrivals were not on time. Travelers are thus regularly interested in receiving arrival and departure information. Many of these travelers, and especially those travelers at an airport, may not necessarily have access to a computer. However, maintaining and providing arrival and departure information is expensive. Currently, there does not exist a financially viable solution that allows third parties to provide arrival and departure information to travelers.

Thus, as noted above, there currently exists deficiencies in providing flight information in the prior art.

### SUMMARY OF THE INVENTION

Accordingly, one aspect of the present invention is to provide a system for providing real-time flight information to a user over a telephone network. The system includes a server having access to real-time flight information, an interface in communication with the server and a telephone network, a database in communication with the server. The database is continuously updated with the real-time flight information. The database contains a plurality of advertisements. The server is configured to prompt a user to enter flight identifying information over the telephone network, receive the flight identifying information from the user, determine matching flight information from the database based upon the flight identifying information, and to provide at least one of the plurality of advertisements to the user over the telephone network while the flight information is being determined. Advertiser fees are provided from one or more advertisers for each of the plurality of advertisements provided to the user.

Another aspect of the present invention is to provide a computer program embodied on a computer readable medium for providing real-time flight information to a user over a telephone network. The computer program includes a first computer code for prompting a user to enter flight identifying information over the telephone network, a second computer code for receiving the flight identifying information from the user, a third computer code for determining flight information based upon the flight identifying information, and a fourth computer code for providing at least one of a plurality of advertisements to the user over the telephone network while the flight information is being determined. The advertiser fees are provided from one or more advertisers for each of the plurality of advertisements provided to the user.

Yet another aspect of the present invention is to provide a system for providing real-time flight information to a user over a telephone network. The system includes a server having access to real-time flight information, an interface in communication with the server and a telephone network, and a database in communication with the server. The database is continuously updated with the real-time flight information. The database contains a plurality of advertisements. The server is configured to receive caller identification information corresponding to the user, associate the caller identification information with a user configuration that is configured to substantially not receive prompts to enter flight identifying information over the telephone network, receive the flight identifying information from the user, determine matching flight information from the database based upon the flight identifying information, and provide at least one of the plurality of advertisements to the user over the telephone network while the flight information is being determined, wherein advertiser fees are provided from one or more advertisers for each of the plurality of advertisements provided to the user.

### BRIEF DESCRIPTION OF THE DRAWINGS

A more complete appreciation of the present invention and many of the attendant advantages thereof will be readily obtained as the same becomes better understood by reference to the following detailed description when considered in conjunction with the accompanying drawings, wherein:

FIG. 1 is a block diagram of a system for providing real-time flight information over a telephone network; and

FIGS. 2-12 are flow charts illustrating a method for providing real-time flight information over a telephone network in accordance with an embodiment of the present invention.

### DETAILED DESCRIPTION THE PREFERRED EMBODIMENTS

Referring now to the drawings, wherein like reference numerals designate identical or corresponding parts throughout the several views, preferred embodiments of the present invention are described.

The present invention, commercially marketed as “1-800-Flights,” provides a financially viable service to consumers and an advertising opportunity for advertisers. It provides a user access to timely and valuable flight information for almost any airline via a telephone connection. It also provides an advertiser with a captive and selective audience for advertisement. In one embodiment, the ability to receive flight status information via a telephone connection is completely, or at least substantially, automated.

As previously mentioned, most seasoned travelers and a substantial number of the travelers generally have experienced a delay in either arrival or departure times. One objective of the present invention is to entice travelers and/or drivers picking up travelers at the airport to utilize the system of the present invention for up-to-date arrival and departure information.

The present invention may be utilized by a variety of companies in the travel industry, including, without limitation, travel related companies which do not currently offer flight status information via the telephone. The present invention provides multiple advantages to a company. First, it provides a service to a user interested in quick and easy flight information via a telephone connection. Second, it increases the company's competitiveness with other travel companies. Third, the present invention may be used to advertise the company and/or other companies to new and existing users. Additionally, in one embodiment, the present invention may be used to connect users with company representatives responsible for handling the user's interest. Advertisements paid for by outside companies allow the cost of operating the service to be reduced, if not eliminated. Alternatively, advertisements paid for by outside companies provide a profit beyond the cost of operating the service. Advertisers may be charged based on any means known in the art, including, without limitation, the number of message played (i.e., a per message charge), the duration of the message, the time-of-day that the message is played, and the like.

Optionally, the advertisement may include an option for the user to receive a coupon via a text message, an email, a facsimile or the like. According to this embodiment, the user is prompted to specify whether the user desires to receive a coupon via a text message, an email and/or a facsimile. A coupon will be transmitted to the user, upon appropriate selection by the user.

Optionally, caller identification information and/or other user identification information may be associated with the coupon in order to track redemption of the coupon. Under this embodiment, the system may be configured (as further discussed below) to customize advertisements and/or coupon offers based on the user's previous coupon redemptions.

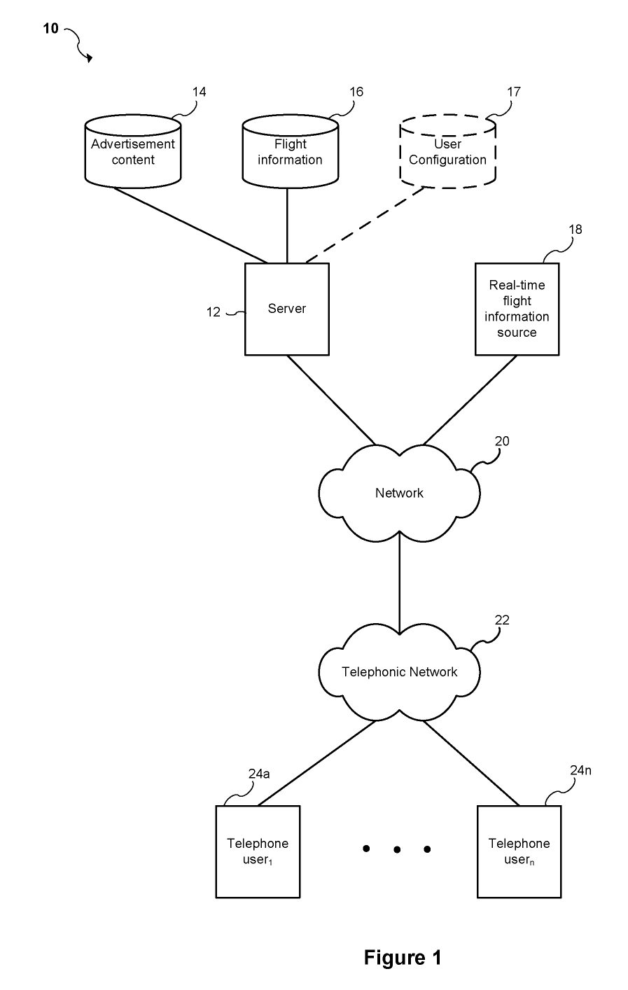

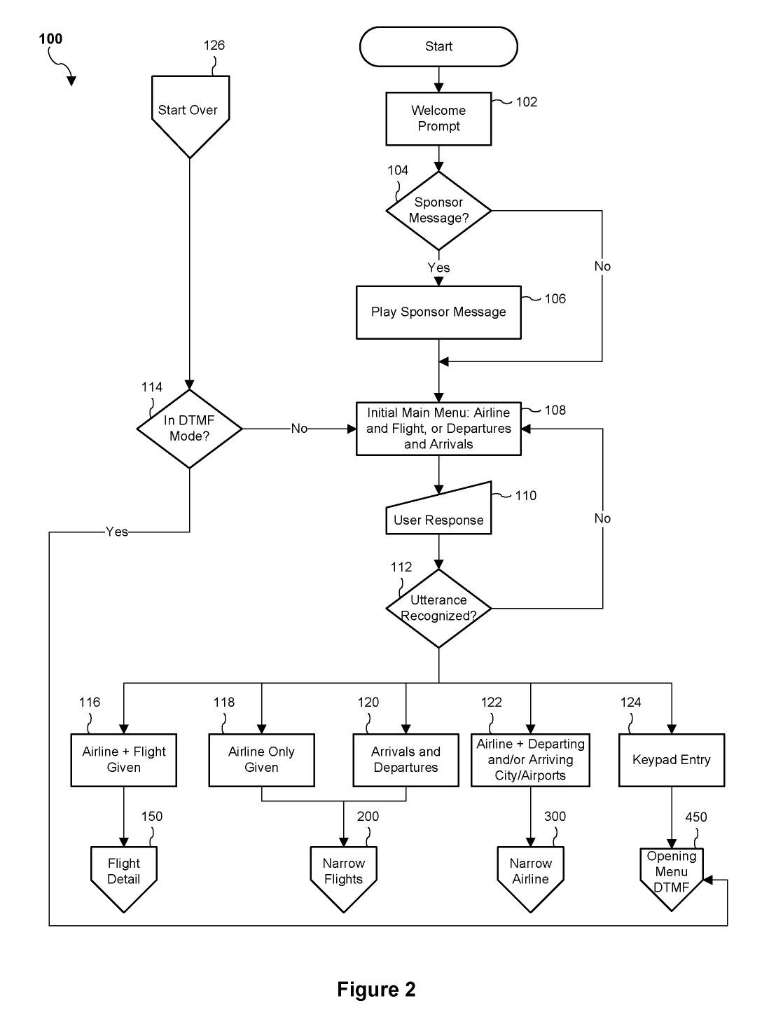

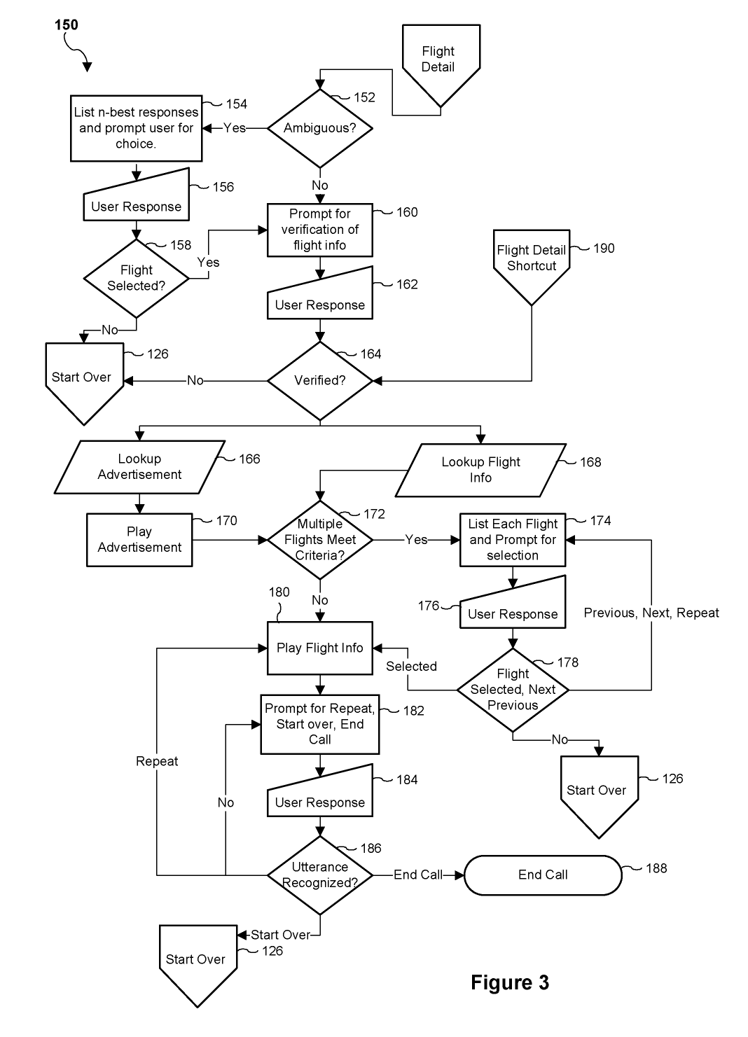

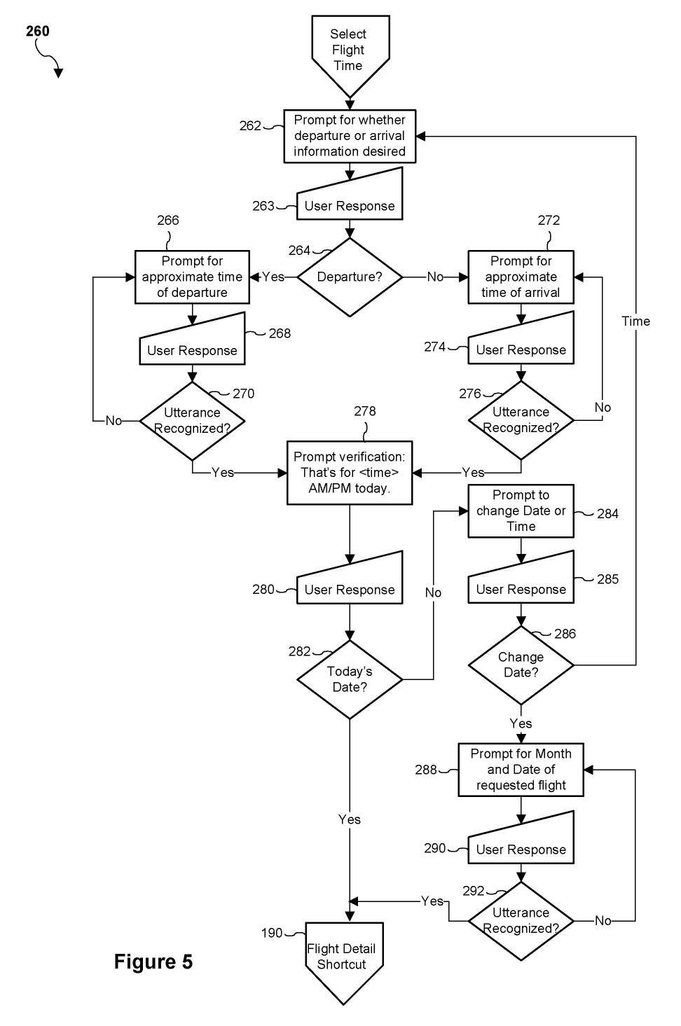

Referring to FIGS. 1-11, flow charts illustrating a method for providing flight information over a telephone network in accordance with an embodiment of the present invention are shown. According to this embodiment, as shown at block 102, after receiving a telephone call from a user, the user is provided an introductory message, such as a welcome prompt. As shown at blocks 104 and 106, the user may optionally be provided an initial sponsor message. The user is presented with an initial prompt to determine what type of information the user is interested in receiving, as shown at block 108. Possible options include, without limitation, airline and flight information, airline information, arrival and departure information, airline and departure information and/or arriving city or airport. As shown at block 110, the system waits a pre-determined period of time for a user response. As shown at block 112, a determination is made as to whether the user response is recognized by the system. If the user response is not recognized, then the user is again prompted for the type of information the user is interested in receiving, as shown at block 108. The processing at blocks 108-112 will continue a predetermined number of times (i.e., one or more) before looping is terminated. As shown at block 116, if the user requested airline and flight information, then processing continues at block 150 as further described below with respect to FIG. 2. As shown at blocks 118 and 120, if the user requested airline information, then processing continues at block 200 as further described below with respect to FIG. 3. As shown at block 122, if the user requested airline and departing and/or arriving city or airports, then processing continues at block 300 as further described below with respect to FIG. 5. As shown at block 124, if a touchtone/88, also referred to herein as DTMF mode, is detected then processing continues at block 450.

Optionally, the user may be associated with a user configuration and/or user membership 17, as represented in FIG. 1. According to this embodiment, the user's preferences and/or other personal information may be stored in a database and used to customize the user's interaction with the system. A user configuration and/or user membership 17 may be configured via the telephone or a website application. The creation, modification and deletion of a user configuration and/or user membership 17 may be automated, or at least partially automated by the system and may include operator assistance (although not required). A user's configuration may or may not be incorporated with the user's caller identification, as discussed below.

Optionally, caller identification information, such as the user telephone number, may be associated with the user configuration and/or user membership 17, and/or other tracking information.

In one embodiment the system may be configured for the user to at least substantially not receive prompts. This embodiment is particularly useful for an advanced or frequent user of the system to reduce the time required for the user to receive flight information. According to this embodiment, the user is prompted on whether the user desires to establish a user configuration and/or user membership 17 indicating that all, or at least substantially all, of the prompts are eliminated. Thereafter, upon activation by the user, the user would not be prompted in situations where the system associates the user's caller identification information, such as the user telephone number, with a user configuration and/or user membership 17 that is configured to at least substantially not receive prompts.

In another embodiment, caller identification information, such as the user telephone number, may be tracked to customize the user's interaction with the system. For instance, upon recognition of the user's caller identification information, the system may be configured to provide a series of advertisements to the user in order to reduce repeating the same advertisement to the same user on successive calls to the system. The system may also be configured to provide advertisements that are based on known interests of the user and/or previous flight information selections by the user. According this embodiment, if the user has previously requested flight information from a particular departure and/or arrival airport or has requested a particular airline, then flight information may be at least initially limited based on such previous flight selections. Tracking of previous flight information may include, without limitation, an airline, an arrival city, a departure city, an arrival time, a departure time, class of service (i.e., first class, business class, economy or the like), meal preference, car rental preference, and the like. For instance, if the user has previously requested flight information for American Airlines flights departing out of Hobby Airport in Houston, Tex., then similar flight information may be at least initially provided and/or the user may be prompted to select whether the user desires to limit flight information to American Airlines flight information, Hobby Airport departure information and/or Houston area airport information. Upon a subsequent call, if the user's previous flight information request is currently based on a pending flight, then the user may be provided updated information based on the previous request without requiring the user to enter, or at least reduce entry of, the same flight information. Alternatively, the departure and/or arrival information may be at least initially based on the area code of the caller identification.

Referring to FIG. 2, a flow chart illustrating a airline and flight information request in accordance with an embodiment of the present invention is shown. As shown at block 152, a determination is made as to whether the airline and flight information request is ambiguous. As used herein, ambiguous information may include the user providing too much information (i.e., unexpected or superfluous information) or too little information, and may also include the user providing contradictory information. If the airline and flight information request is non-ambiguous, then processing continues at block 160, as discussed below.

If the airline and flight information request is ambiguous, then a predefined number of possible flights are presented to the user and the user is prompted to enter a choice, as shown at block 154. As shown at blocks 156 and 158, after receiving a user response, a determination is made as to whether the response is a valid flight selection. If the response is not a valid flight selection, then processing continues at the opening menu as shown at block 126 of FIG. 1. If the response is a valid flight selection, then processing continues at block 160.

As shown at block 160, the user is prompted to verify flight information. After receiving a user response, a determination is made as to whether the response is a valid verification of the flight information, as shown at blocks 162 and 164. If the response is not a valid verification of the flight information, then processing continues at the opening menu as shown at block 126 of FIG. 1.

If the response is a valid verification of flight information, then the matching flight information is gathered, as shown at block 168. The matching flight information may be gathered from any available source including, without limitation, a local or networked database. As shown at blocks 166 and 170, while the flight information is being gathered, one or more advertisements are retrieved and presented to the user.

As shown at block 172, a determination is made as to whether multiple flights meet the flight information criteria. If a single flight meets the flight information criteria, then processing continues at block 180, as discussed below. If multiple flights meet the flight information criteria, then the flights are presented to the user until a flight is selected, as shown at blocks 174-178. If a predetermined number of iterations occur without selecting a flight, then processing continues at the opening menu as shown at block 126 of FIG. 1. Upon selection of a flight, processing continues at block 180.

As shown at block 180, flight information is presented to the user. The user is then prompted to either repeat the information, start over or end the call, as shown at block 182. After receiving a user response, a determination is made as to whether the response is recognized, as shown at blocks 184 and 186. If the response is to repeat the flight information, then processing continues at block 180. If the response is to end the call, then the call is terminated, as shown at block 188. If the response is to start over, then processing continues at the opening menu as shown at block 126 of FIG. 1. Otherwise, if the response is not recognized, then processing continues at block 182 for a predetermined number of times. In one embodiment, processing for the airline and flight information request begins at block 190.

Referring to FIG. 3, a flow chart illustrating narrowing flights in accordance with an embodiment of the present invention is shown. As shown at block 202, a determination is made as to whether the airline is known. If the airline is known, then processing continues at block 216, as discussed below. If the airline is not known, then prompt for the airline, as shown at block 204. After receiving the user response, a determination is made as to whether the airline is ambiguous, as shown at blocks 206 and 208. If the airline is non-ambiguous, then processing continues at block 216, as discussed below.

If the airline is ambiguous, then a predefined number of possible airlines are presented to the user and the user is prompted to enter a choice, as shown at block 210. As shown at blocks 212 and 214, after receiving a user response, a determination is made as to whether the response is a valid airline selection. If the response is not a valid airline selection, then processing continues at block 204. If the response is a valid airline selection, then processing continues at block 216.

The user is prompted for a departure city, as shown at block 216. After receiving the user response, a determination is made as to whether the departure city is ambiguous, as shown at blocks 218 and 220. If the departure city is non-ambiguous, then processing continues at block 228, as discussed below.

If the departure city is ambiguous, then a predefined number of possible departure cities are presented to the user and the user is prompted to enter a choice, as shown at block 222. As shown at blocks 224 and 226, after receiving a user response, a determination is made as to whether the response is a valid departure city selection. If the response is not a valid departure city selection, then processing continues at block 216. If the response is a valid departure city selection, then processing continues at block 228.

As shown at block 228, a determination is made as to whether there are multiple airports for the departure city. If there not multiple airports for the departure city, then processing continues at block 236, as discussed below. If there are multiple cities for the departure city, then the user is prompted to select an airport, as shown at block 236. As shown at blocks 232 and 234, after receiving a user response, a determination is made as to whether the response is a valid airport selection. If the response is not a valid airport selection, then processing continues at block 230. If the response is a valid airport selection, then processing continues at block 236.

The user is prompted for an arrival city, as shown at block 236. After receiving the user response, a determination is made as to whether the arrival city is ambiguous, as shown at blocks 238 and 240. If the arrival city is non-ambiguous, then processing continues at block 228, as discussed below.

If the arrival city is ambiguous, then a predefined number of possible arrival cities are presented to the user and the user is prompted to enter a choice, as shown at block 242. As shown at blocks 244 and 246, after receiving a user response, a determination is made as to whether the response is a valid arrival city selection. If the response is not a valid arrival city selection, then processing continues at block 236. If the response is a valid arrival city selection, then processing continues at block 248.

As shown at block 248, a determination is made as to whether there are multiple airports for the arrival city. If there not multiple airports for the arrival city, then processing continues at block 254, as discussed below. If there are multiple airports for the arrival city, then the user is prompted to select an airport, as shown at block 250. As shown at blocks 252 and 253, after receiving a user response, a determination is made as to whether the response is a valid airport selection. If the response is not a valid airport selection, then processing continues at block 250. If the response is a valid airport selection, then processing continues at block 254.

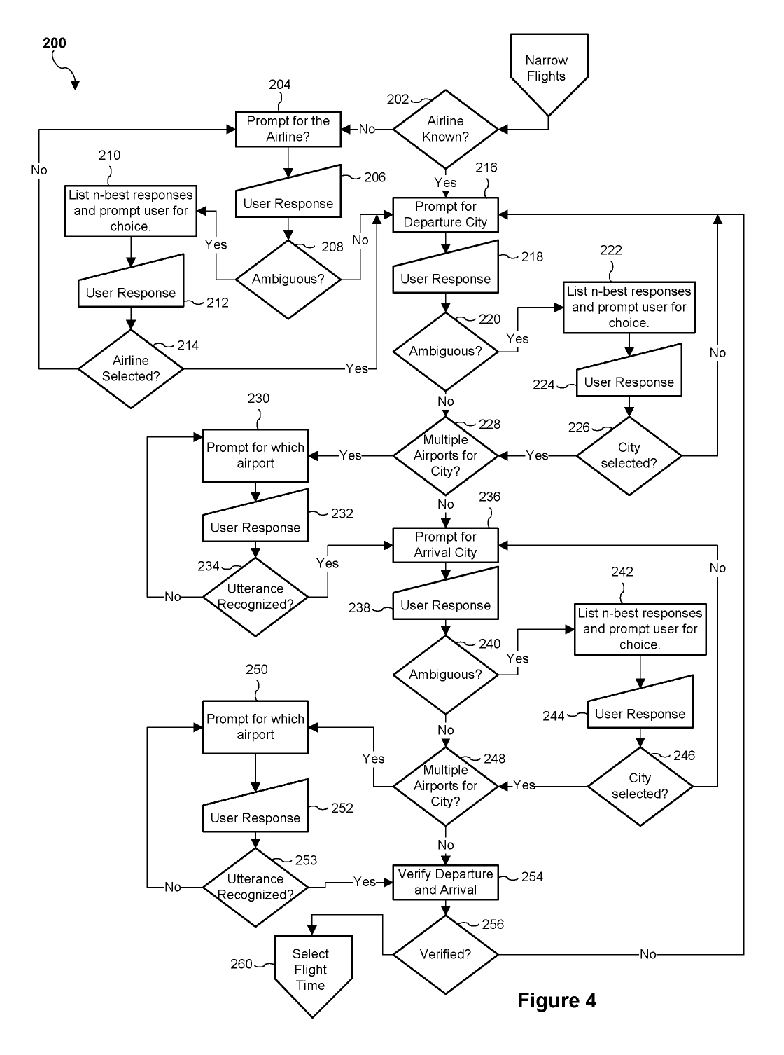

The departure and arrival information are then verified, as shown at block 256. As shown at block 256, a determination is made as to whether the departure and arrival information are valid. If the departure and arrival information are not valid, then processing continues at block 216. If the departure and arrival information are valid, then processing continues at block 260 as described below with respect to FIG. 4.

Referring to FIG. 4, a flow chart illustrating selecting a flight time in accordance with an embodiment of the present invention is shown. As shown at block 262, the user is prompted for whether departure or arrival information is desired. As shown at blocks 263 and 264, after receiving a user response, a determination is made as to whether departure information is desired. If departure information is not desired, then processing continues at block 272.

As shown at block 266, if departure information is desired, then the user is prompted for the approximate time of departure. After receiving a user response, a determination is made as to whether the response is recognized, as shown at blocks 268 and 270. If the response is recognized, then processing continues at block 278. Otherwise, if the response is not recognized, then processing continues at block 266 for a predetermined number of times.

As shown at block 272, if arrival information is desired, then the user is prompted for the approximate time of arrival. After receiving a user response, a determination is made as to whether the response is recognized, as shown at blocks 274 and 276. If the response is recognized, then processing continues at block 278. Otherwise, if the response is not recognized, then processing continues at block 272 for a predetermined number of times.

As shown at block 278, the user is prompted to verify whether the flight information should be provided for today's date and the entered arrival or departure time. After receiving a user response, a determination is made as to whether the flight information should be provided for today's date and the entered arrival or departure time, as shown at blocks 280 and 282. If flight information for today's date and the entered arrival or departure time is desired, then processing continues at block 190 as shown in FIG. 2.

If flight information for another date or another arrival or departure time is desired, then the user is prompted whether to change the date or the time, as shown at block 284. After receiving a user response, a determination is made as to whether the user desires to change the date, as shown at blocks 285 and 286. If the response is not to change the date, then processing continues at block 262. If the response is to change the date, then the user is prompted to enter a date for the requested flight. After receiving a user response, a determination is made as to whether the response is recognized, as shown at blocks 290 and 292. If the response is recognized, then processing continues at block 190. Otherwise, if the response is not recognized, then processing continues at block 288 for a predetermined number of times.

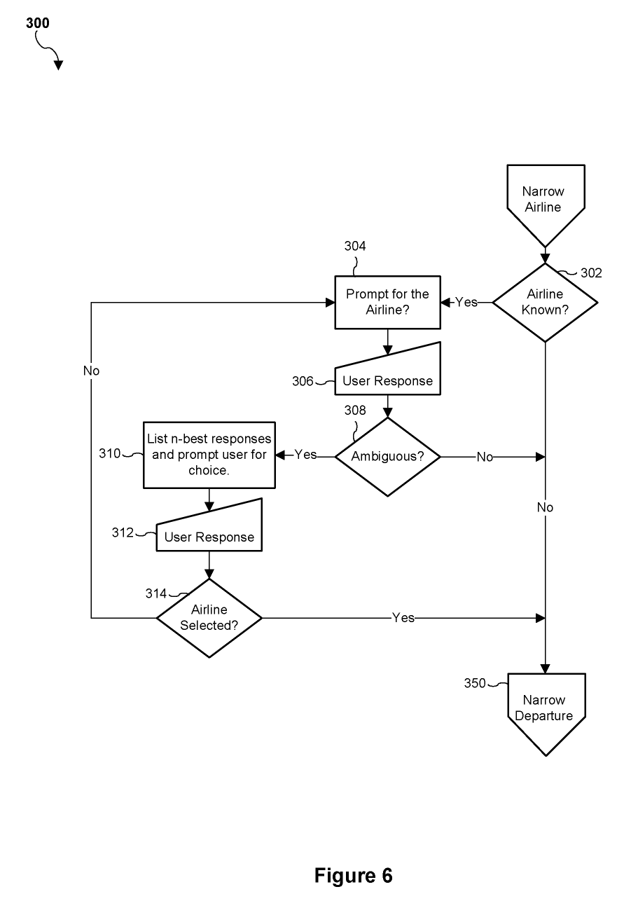

Referring to FIG. 5, a flow chart illustrating narrowing an airline in accordance with an embodiment of the present invention is shown. As shown at block 302, a determination is made as to whether the airline is known. If the airline is not known, then processing continues at block 350, as discussed with respect to FIG. 6. If the airline is known, then prompt for the airline, as shown at block 304. After receiving the user response, a determination is made as to whether the airline is ambiguous, as shown at blocks 306 and 308. If the airline is non-ambiguous, then processing continues at block 350, as discussed with respect to FIG. 6.

If the airline is ambiguous, then a predefined number of possible airlines are presented to the user and the user is prompted to enter a choice, as shown at block 310. As shown at blocks 312 and 314, after receiving a user response, a determination is made as to whether the response is a valid airline selection. If the response is not a valid airline selection, then processing continues at block 304. If the response is a valid airline selection, then processing continues at block 350, as discussed with respect to FIG. 6.

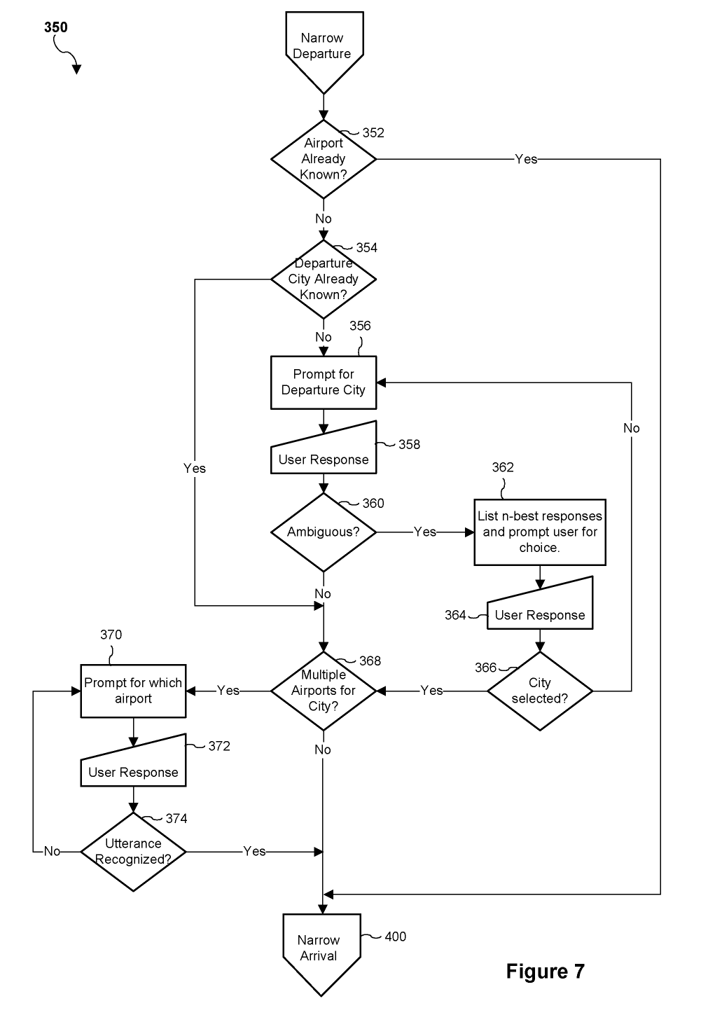

Referring to FIG. 6, a flow chart illustrating narrowing departure information in accordance with an embodiment of the present invention is shown. As shown at block 352, a determination is made as to whether the airport is known. If the airport is known, then processing continues at block 400, as discussed with respect to FIG. 7.

If the airport is not already known, then a determination is made as to whether the departure city is already known, as shown at block 345. If the departure city is already known, then processing continues at block 368. If the departure city is not already known, then the user is prompted for a departure city, as shown at block 356. After receiving the user response, a determination is made as to whether the departure city is ambiguous, as shown at blocks 358 and 360. If the departure city is non-ambiguous, then processing continues at block 368, as discussed below.

If the departure city is ambiguous, then a predefined number of possible departure cities are presented to the user and the user is prompted to enter a choice, as shown at block 362. As shown at blocks 364 and 366, after receiving a user response, a determination is made as to whether the response is a valid departure city selection. If the response is not a valid departure city selection, then processing continues at block 356. If the response is a valid departure city selection, then processing continues at block 368.

As shown at block 368, a determination is made as to whether there are multiple airports for the departure city. If there not multiple airports for the departure city, then processing continues at block 400, as discussed below with respect to FIG. 7. If there are multiple cities for the departure city, then the user is prompted to select an airport, as shown at block 370. As shown at blocks 372 and 374, after receiving a user response, a determination is made as to whether the response is a valid airport selection. If the response is not a valid airport selection, then processing continues at block 370. If the response is a valid airport selection, then processing continues at block 400, as discussed below with respect to FIG. 7.

Referring to FIG. 7, a flow chart illustrating narrowing arrival information in accordance with an embodiment of the present invention is shown. As shown at block 402, a determination is made as to whether the airport is known. If the airport is known, then processing continues at block 260, as discussed with respect to FIG. 4.

If the airport is not known, then a determination is made as to whether the arrival city is already known, as shown at block 404. If the arrival city is already known, then processing continues at block 418. If the arrival city is not already known, then the user is prompted for an arrival city, as shown at block 406. After receiving the user response, a determination is made as to whether the arrival city is ambiguous, as shown at blocks 408 and 410. If the arrival city is non-ambiguous, then processing continues at block 418, as discussed below.

If the arrival city is ambiguous, then a predefined number of possible arrival cities are presented to the user and the user is prompted to enter a choice, as shown at block 412. As shown at blocks 414 and 416, after receiving a user response, a determination is made as to whether the response is a valid arrival city selection. If the response is not a valid arrival city selection, then processing continues at block 406. If the response is a valid arrival city selection, then processing continues at block 418.

As shown at block 418, a determination is made as to whether there are multiple airports for the arrival city. If there not multiple airports for the arrival city, then processing continues at block 260, as discussed with respect to FIG. 4. If there are multiple airports for the arrival city, then the user is prompted to select an airport, as shown at block 420. As shown at blocks 422 and 424, after receiving a user response, a determination is made as to whether the response is a valid airport selection. If the response is not a valid airport selection, then processing continues at block 406. If the response is a valid airport selection, then processing continues at block 260, as discussed with respect to FIG. 4.

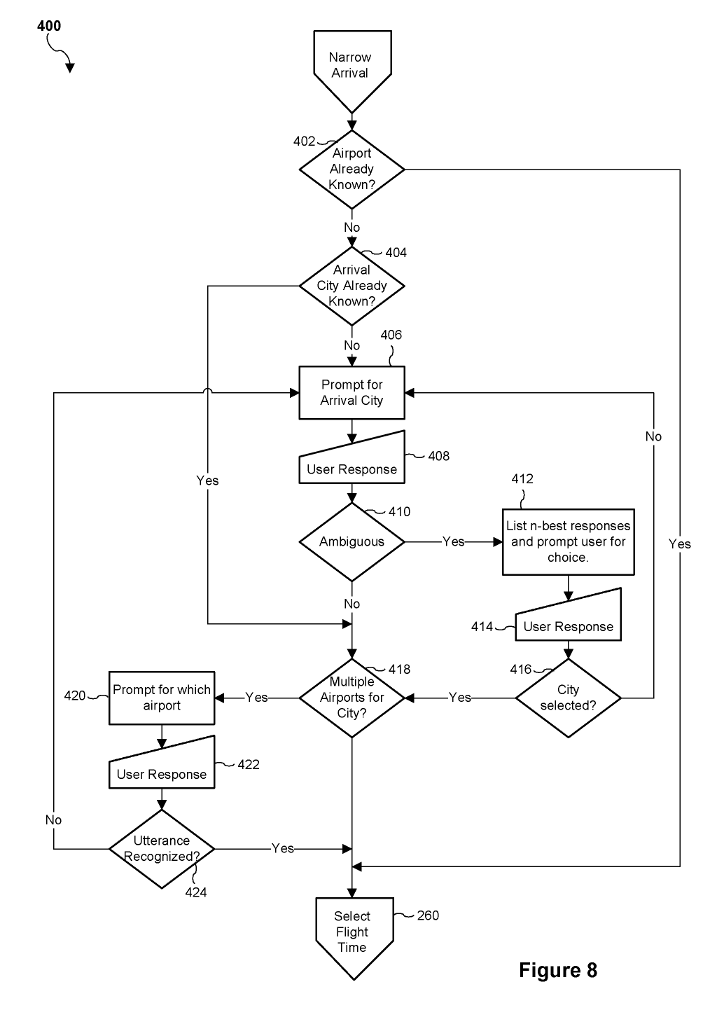

Referring to FIG. 8, a flow chart illustrating processing dual tone multi frequency (DTMF) in accordance with an embodiment of the present invention is shown. As is known by those of ordinary skill in the art, DTMF is a signal generated when a user presses a telephone touch key. As shown at block 452, the user is notified that the system is in DTMF mode. The user is then provided an opening menu to press a key if an airline and flight is known or another key for departure and/or arrival information, as shown at block 454. According to one possible implementation, the system prompts the user to press “1” if the airline and flight information is known or to press “2” for departure and arrival information.

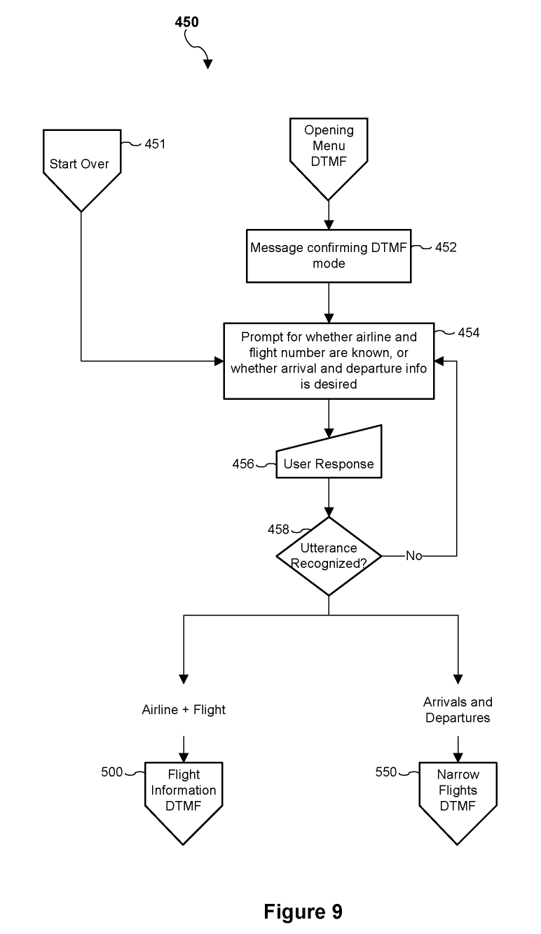

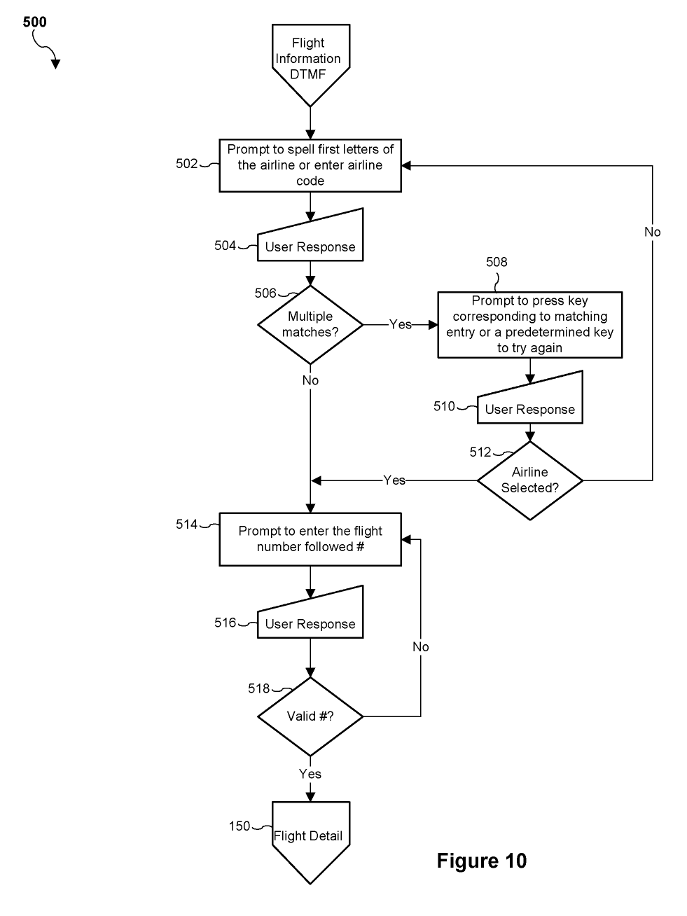

After receiving a user response, a determination is made as to whether the response is recognized, as shown at blocks 456 and 458. If the response is not recognized, then processing continues at block 454 for a predetermined number of times. If the response is to provide airline and flight information, then processing continues at block 500, as discussed below with respect to FIG. 9. Otherwise, if the response is to provide arrival and departure information, then processing continues at block 550, as discussed below with respect to FIG. 10.

Referring to FIG. 9, a flow chart illustrating processing flight information using DTMF in accordance with an embodiment of the present invention is shown. The user is prompted to spell a predetermined number of letters of an airline or to enter an airplane code using the keypad, as shown at block 502. According to one possible implementation, the system prompts the user to spell the first 4 letters of the airline or enter the 2 digit airline code.

After receiving a user response, a determination is made as to whether there are multiple airlines that match the response, as shown at blocks 504 and 506. If there not multiple matching airlines, then processing continues at block 514, as discussed below. If there are multiple matching airlines, then the user is prompted to select an airline using the keypad, as shown at block 508. According to one possible implementation, the system prompts the user to press “1” for the first matching entry, press “2” for the second matching entry, . . . , press n for the n^{th} entry, or press “*” to try again. As shown at blocks 510 and 512, after receiving a user response, a determination is made as to whether the response is a valid airline selection. If the response is not a valid airline selection, then processing continues at block 502. If the response is a valid airport selection, then processing continues at block 514.

At block 514, the user is prompted to enter a flight number using the keypad. As shown at blocks 516 and 518, after receiving a user response, a determination is made as to whether the response is a valid flight number. If the response is not a valid flight number, then processing continues at block 514. If the response is a valid flight number, then processing continues at block 150, as discussed with respect to FIG. 2, using the keypad rather than voice commands.

The user is prompted for an arrival city, as shown at block 236. After receiving the user response, a determination is made as to whether the arrival city is ambiguous, as shown at blocks 238 and 240. If the arrival city is non-ambiguous, then processing continues at block 228, as discussed below.

Referring to FIG. 10, a flow chart illustrating narrowing flight information using DTMF in accordance with an embodiment of the present invention is shown. As shown at block 552, a determination is made as to whether the airline is known. If the airline is known, then processing continues at block 566, as discussed below. If the airline is not known, then prompt the user to spell a predetermined number of letters of the airline using the keypad, as shown at block 554. According to one possible implementation, the system prompts the user to spell the first 4 letters of the airline or enter the 2 digit airline code. After receiving the user response, a determination is made as to whether the airline is ambiguous, as shown at blocks 556 and 558. If the airline is non-ambiguous, then processing continues at block 566, as discussed below.

If the airline is ambiguous, then a predefined number of possible airlines are presented to the user and the user is prompted to enter a choice using the keypad, as shown at block 560. As shown at blocks 562 and 564, after receiving a user response, a determination is made as to whether the response is a valid airline selection. If the response is not a valid airline selection, then processing continues at block 554. If the response is a valid airline selection, then processing continues at block 566.

The user is prompted for a departure city using a keypad, as shown at block 566. According to one possible implementation, the system prompts the user to spell the first 4 letters of the departure city. After receiving the user response, a determination is made as to whether the departure city is ambiguous, as shown at blocks 568 and 570. If the departure city is non-ambiguous, then processing continues at block 578, as discussed below.

If the departure city is ambiguous, then a predefined number of possible departure cities are presented to the user and the user is prompted to enter a choice using the keypad, as shown at block 572. As shown at blocks 574 and 576, after receiving a user response, a determination is made as to whether the response is a valid departure city selection. If the response is not a valid departure city selection, then processing continues at block 566. If the response is a valid departure city selection, then processing continues at block 578.

As shown at block 578, a determination is made as to whether there are multiple airports for the departure city. If there not multiple airports for the departure city, then processing continues at block 586, as discussed below. If there are multiple cities for the departure city, then the user is prompted to select an airport using the keypad, as shown at block 580. As shown at blocks 582 and 584, after receiving a user response, a determination is made as to whether the response is a valid airport selection. If the response is not a valid airport selection, then processing continues at block 580. If the response is a valid airport selection, then processing continues at block 586.

The user is prompted to enter a predetermined number of letters of an arrival city using the keypad, as shown at block 586. According to one possible implementation, the system prompts the user to spell the first 4 letters of the arrival city. After receiving the user response, a determination is made as to whether the arrival city is ambiguous, as shown at blocks 588 and 590. If the arrival city is non-ambiguous, then processing continues at block 598, as discussed below.

If the arrival city is ambiguous, then a predefined number of possible arrival cities are presented to the user and the user is prompted to enter a choice using the keypad, as shown at block 592. As shown at blocks 594 and 596, after receiving a user response, a determination is made as to whether the response is a valid arrival city selection. If the response is not a valid arrival city selection, then processing continues at block 586. If the response is a valid arrival city selection, then processing continues at block 598.

As shown at block 598, a determination is made as to whether there are multiple airports for the arrival city. If there not multiple airports for the arrival city, then processing continues at block 604, as discussed below. If there are multiple airports for the arrival city, then the user is prompted to select an airport using the keypad, as shown at block 600. As shown at blocks 602 and 603, after receiving a user response, a determination is made as to whether the response is a valid airport selection. If the response is not a valid airport selection, then processing continues at block 600. If the response is a valid airport selection, then processing continues at block 604.

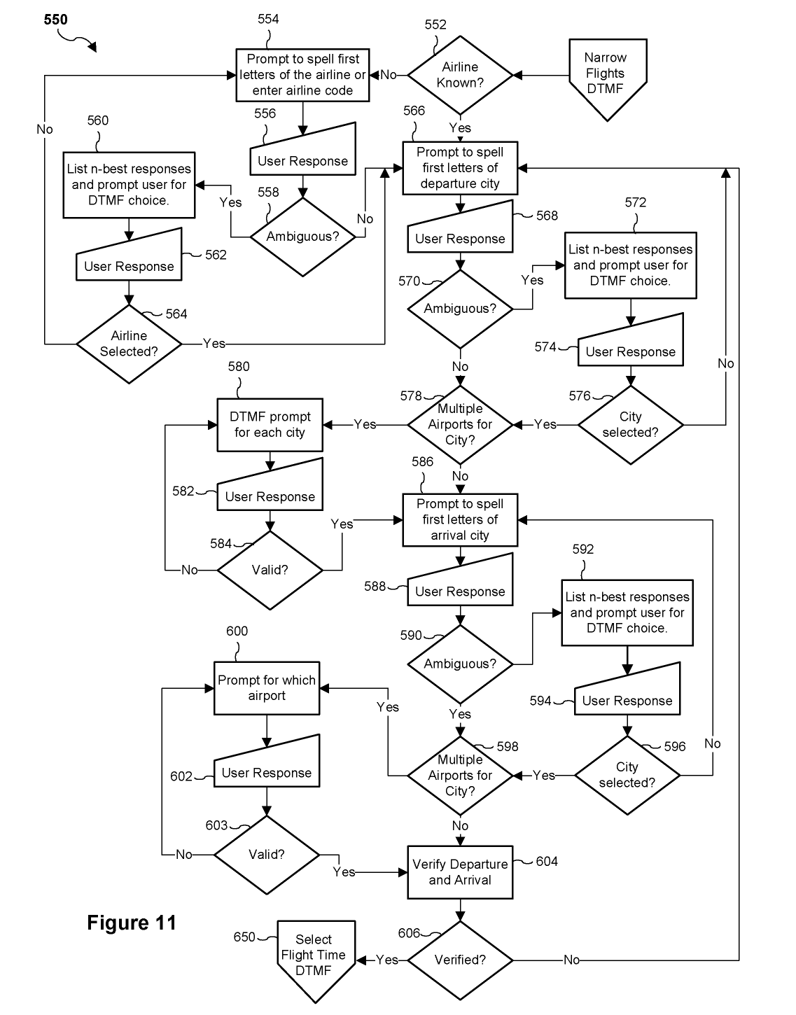

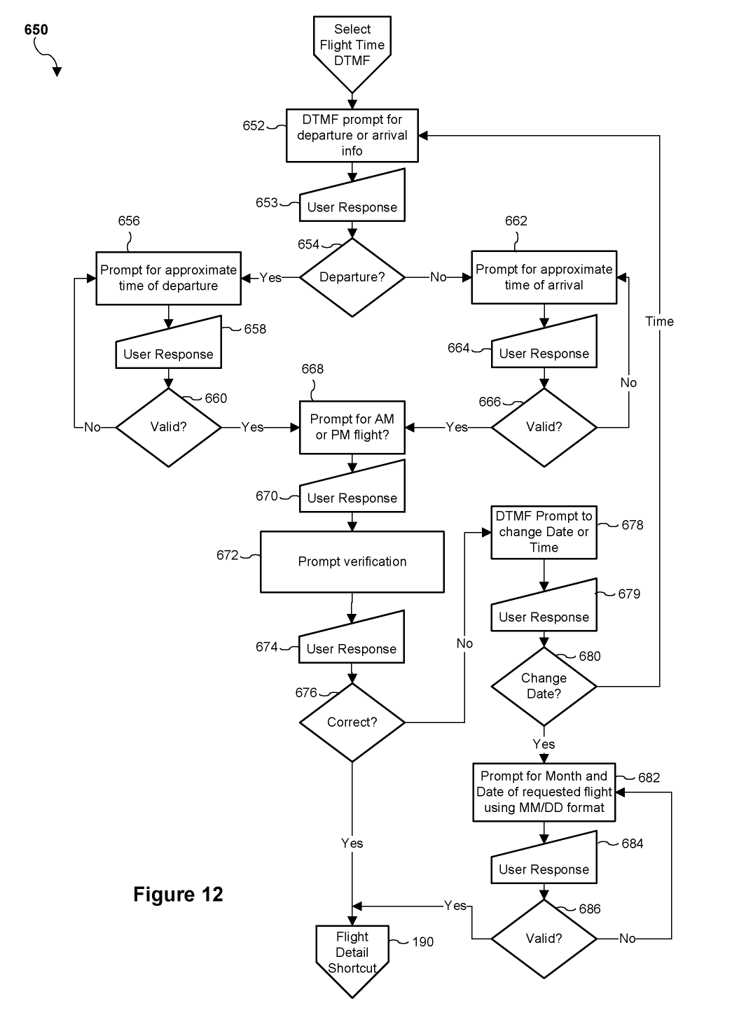

The departure and arrival information are then verified, as shown at block 604. As shown at block 606, a determination is made as to whether the departure and arrival information are valid. If the departure and arrival information are not valid, then processing continues at block 566. If the departure and arrival information are valid, then processing continues at block 650, as described below with respect to FIG. 11.

Referring to FIG. 11, a flow chart illustrating selecting a flight time using DTMF in accordance with an embodiment of the present invention is shown. As shown at block 652, the user is prompted for whether departure or arrival information is desired using a keypad. As shown at blocks 653 and 654, after receiving a user response, a determination is made as to whether departure information is desired. If departure information is not desired, then processing continues at block 662.

As shown at block 656, if departure information is desired, then the user is prompted for the approximate time of departure using a keypad. According to one possible implementation, the system prompts the user for the approximate time of departure as a 4 digit DTMF. After receiving a user response, a determination is made as to whether the response is recognized, as shown at blocks 658 and 660. If the response is recognized, then processing continues at block 668. Otherwise, if the response is not recognized, then processing continues at block 656 for a predetermined number of times.

As shown at block 662, if arrival information is desired, then the user is prompted for the approximate time of arrival using a keypad. According to one possible implementation, the system prompts the user for the approximate time of arrival as a 4 digit DTMF. After receiving a user response, a determination is made as to whether the response is recognized, as shown at blocks 664 and 666. If the response is recognized, then processing continues at block 668. Otherwise, if the response is not recognized, then processing continues at block 662 for a predetermined number of times.

As shown at block 668, the user is prompted to verify whether the flight information should be provided for the morning or afternoon. According to one possible implementation, the system prompts the use to press “1” for morning flights or “2” for afternoon flights. After receiving a user response, the user is prompted to verify the time and to verify whether to use today's date using a keypad, as shown at blocks 670 and 672. According to one possible implementation, the system prompts the user to press “1” if the time is correct or “2” the time is incorrect. After receiving a user response, a determination is made as to whether the flight information should be provided for today's date and the entered arrival or departure time, as shown at blocks 670 and. If flight information for today's date and the entered arrival or departure time is desired, then processing continues at block 190, as shown in FIG. 2, using the keypad.

If flight information for another date or another arrival or departure time is desired, then the user is prompted whether to change the date or the time, as shown at block 678. After receiving a user response, a determination is made as to whether the user desires to change the date, as shown at blocks 679 and 680. If the response is not to change the date, then processing continues at block 680. If the response is to change the date, then the user is prompted to enter a date for the requested flight using the keypad, as shown at block 682. After receiving a user response, a determination is made as to whether the response is recognized, as shown at blocks 684 and 686. If the response is recognized, then processing continues at block 190. Otherwise, if the response is not recognized, then processing continues at block 682 for a predetermined number of times.

The system may also be configured to provide other pertinent travel information to the user. For instance, the system may be configured to provide, without limitation, weather related information, security information, parking information, area restaurant information and the like.

The present invention thus includes a computer program which may be hosted on a storage medium and includes instructions which perform the processes set forth in the present specification. The storage medium can include, but is not limited to, any type of disk including floppy disks, optical disks, CD-ROMs, magneto-optical disks, ROMs, RAMs, EPROMs, EEPROMs, flash memory, magnetic or optical cards, or any type of media suitable for storing electronic instructions.

Obviously, many other modifications and variations of the present invention are possible in light of the above teachings. The specific embodiments discussed herein are merely illustrative, and are not meant to limit the scope of the present invention in any manner. It is therefore to be understood that within the scope of the disclosed concept, the invention may be practiced otherwise then as specifically described.

1. A system for providing real-time flight information to a user over a telephone network, comprising:
a server having access to real-time flight information;
an interface in communication with the server and a telephone network;
a database in communication with the server, wherein the database is continuously updated with the real-time flight information, and the database contains a plurality of advertisements; and
wherein the server is configured to:
prompt a user to enter flight identifying information over the telephone network;
receive the flight identifying information from the user;
determine matching flight information from the database based upon the flight identifying information; and
provide at least one of the plurality of advertisements to the user over the telephone network while the flight information is being determined, wherein advertiser fees are provided from one or more advertisers for each of the plurality of advertisements provided to the user.

2. The system of claim 1, wherein the flight identifying information is at least one selected from a group consisting of a flight number, a time of day, an arrival airport, an arrival city, a destination airport, and a destination city.

3. The system of claim 1, wherein the flight identifying information comprises a portion of at least one selected from a group consisting of a flight number, a time of day, an arrival airport, an arrival city, a destination airport, and a destination city.

4. The system of claim 3, wherein fuzzy logic is used to determine the matching flight information.

5. The system of claim 4, wherein the fuzzy logic comprises providing the user a predetermined number of possible flights which are closest to the flight identifying information.

6. The system of claim 1, wherein the server is further configured to provide at least one of the plurality of advertisements to the user over the telephone network upon initiation of the telephone communication with the user.

7. The system of claim 1, wherein the system receives the flight identifying information using DTMF.

8. The system of claim 1, wherein receiving the flight identifying information comprises recognizing one or more voice responses of the user.

9. The system of claim 1, wherein at least a portion of the cost of providing real-time flight information is paid for by the advertisers fees.

10. The system of claim 9, wherein all of the cost of providing real-time flight information is paid for by the advertisers fees.

11. The system of claim 1, wherein the real-time flight information is provided by a third party servicer that is not an airline.

12. The system of claim 1, wherein the real-time flight information is provided by a third party servicer that is not an airline on behalf of the airline.

13. The system of claim 12, wherein a telephone bridge is established between the third party servicer and the airline.

14. The system of claim 1, wherein the server is further configured to prompt the user to specify whether the user desires to receive a coupon via at least one selected from the group consisting of a text message, an email and a facsimile.

15. A computer program embodied on a computer readable medium for providing real-time flight information to a user over a telephone network, comprising:
a first computer code for prompting a user to enter flight identifying information over the telephone network;
a second computer code for receiving the flight identifying information from the user;
a third computer code for determining flight information based upon the flight identifying information; and
a fourth computer code for providing at least one of a plurality of advertisements to the user over the telephone network while the flight information is being determined, wherein advertiser fees are provided from one or more advertisers for each of the plurality of advertisements provided to the user.

16. The computer program of claim 15, wherein the flight identifying information is at least one selected from a group consisting of a flight number, a time of day, an arrival airport, an arrival city, a destination airport, and a destination city.

17. The computer program of claim 15, wherein the flight identifying information comprises a portion of at least one selected from a group consisting of a flight number, a time of day, an arrival airport, an arrival city, a destination airport, and a destination city.

18. The computer program of claim 17, wherein fuzzy logic is used to determine the matching flight information.

19. The computer program of claim 18, wherein the fuzzy logic comprises providing the user a predetermined number of possible flights which are closest to the flight identifying information.

20. The computer program of claim 15, further comprising a fifth computer code for providing at least one of the plurality of advertisements to the user over the telephone network upon initiation of the telephone communication with the user.

21. The computer program of claim 15, wherein the system receives the flight identifying information using DTMF.

22. The computer program of claim 15, wherein receiving the flight identifying information comprises recognizing one or more voice responses of the user.

23. The computer program of claim 15, wherein at least a portion of the cost of providing real-time flight information is paid for by the advertisers fees.

24. The system of claim 23, wherein all of the cost of providing real-time flight information is paid for by the advertisers fees.

25. The computer program of claim 15, wherein the real-time flight information is provided by a third party servicer that is not an airline.

26. The computer program of claim 15, wherein the real-time flight information is provided by a third party servicer that is not an airline on behalf of the airline.

27. The computer program of claim 15, wherein a telephone bridge is established between the third party servicer and the airline.

28. The computer program of claim 15, further comprising a fifth computer code for prompting the user to specify whether the user desires to receive a coupon via at least one selected from the group consisting of a text message, an email and a facsimile.

29. A system for providing real-time flight information to a user over a telephone network, comprising:
a server having access to real-time flight information;
an interface in communication with the server and a telephone network;
a database in communication with the server, wherein the database is continuously updated with the real-time flight information, and the database contains a plurality of advertisements; and
wherein the server is configured to:
receive caller identification information corresponding to the user;
associate the caller identification information with a user configuration that is configured to substantially not receive prompts to enter flight identifying information over the telephone network;
receive the flight identifying information from the user;
determine matching flight information from the database based upon the flight identifying information; and
provide at least one of the plurality of advertisements to the user over the telephone network while the flight information is being determined, wherein advertiser fees are provided from one or more advertisers for each of the plurality of advertisements provided to the user.

30. The system of claim 29, wherein the user is prompted to establish the user configuration to substantially not receive prompts to enter flight identifying information over the telephone network.

31. The system of claim 29, wherein the user configuration is configured to not receive any prompts to enter flight identifying information over the telephone network.
